(19) United States
(12) Patent Application Publication
(10) Pub. No.: US 2026/0145202 A1
(43) Pub. Date: May 28, 2026

(54) METHOD FOR COATING A BODY COMPONENT, COATING DEVICE HAVING A BAG, AND BAG

(71) Applicant: AUDI AG, Ingolstadt (DE)

(72) Inventors: Dirk BÄDER, Fellbach (DE); Andreas EHM, Großmehring (DE)

(73) Assignee: AUDI AG, Ingolstadt (DE)

(21) Appl. No.: 19/372,573

(22) Filed: Oct. 29, 2025

(30) Foreign Application Priority Data
Nov. 27, 2024 (DE) 102024135015.6

(51) Int. Cl. B05D 1/30; B05C 5/00; B05C 11/11; B05D 3/02; B05D 7/14

(52) U.S. Cl. CPC B05D 1/30; B05C 5/00; B05C 11/11; B05D 3/02; B05D 7/14

(57) ABSTRACT

A method for coating a coating area of a body component of a body using a coating component. The coating component is deliberately released from a bag attached to the body component, which bag is opened automatically within a desired opening area when a predetermined opening criterion is present.

### FIELD

The invention relates to a method for coating a predetermined coating area of a body component of a body of a motor vehicle and/or multiple interconnected body components of the body using at least one coating component. A further aspect of the invention relates to a coating device having a bag for accommodating at least one coating component. A further aspect of the invention relates to such a bag.

### BACKGROUND

According to current standards, body shells are waxed, among other things, for corrosion protection measures. A spray wax system or flooding wax system is typically used for this purpose. With the spray wax system, wax is sprayed on, with the flooding wax system, the component or the entire body is flooded using the wax. In principle, these methods function very well, but they have some disadvantages.

The component to be waxed or coated has to be accessible to the system (both spray and flooding wax). There have to be inlet and outlet holes for the flooding wax and/or openings for a spray nozzle. These openings have to be provided in the design and are usually associated with disadvantages such as structural weakening of the affected component, re-closing during assembly by expensive plugs, etc.

In addition, in order that the wax can be applied, both the wax and the body have to be at a relatively high temperature, which has to be at least high enough for the wax to be liquid. The melting temperatures of the known waxes are in the range of 70 to 90 degrees Celsius, so these methods are very energy-intensive.

A further disadvantage of the known methods by means of spray wax or flooding wax systems is that the application of wax represents an additional process step in production and is therefore expensive and complex. Usually too much wax is applied, in particular with flooding wax. This is not only expensive and a waste of resources, but it can also result in wax contamination/wax carryover in the body, which can result in additional weight, for example up to approximately 2 kg, of “unnecessary” wax in the vehicle, which remains in the vehicle permanently.

In the area of modular motor vehicle assembly, there is a further disadvantage that body components including paint are provided for the final assembly, which can no longer be passed through a wax bath because the paint would suffer.

A method for the precise waxing of body components is known from FR 2 973 262 A1, in which a wax block is placed in an area to be coated and melted there in situ so that the wax is distributed in the area to be coated. The disadvantage here is that during the production process, meticulous care has to be taken to ensure that the body component is only heated to the melting temperature of the wax once, since if it is heated repeatedly, the wax, which has already melted and hardened once, will be melted again and, in case of doubt, will flow out of the area to be coated or will be distributed in an uncontrolled manner. This is problematic because body components are usually heated repeatedly during the production process, for example in the course of immersion in corrosion protection baths and the subsequent baking of the corrosion protection coating. The use of a bare wax block therefore limits the flexibility in the production process, which in turn can have a negative effect on production costs.

A household cleaning glove having an integrated cleaning agent bladder is known from DE 600 31 995 T2.

### SUMMARY

The invention is based on the object of simplifying and making more flexible a coating process for one or more body components.

One aspect of the invention relates to a method for coating a predetermined coating area of a body component of a body and/or multiple interconnected body components of the body using at least one coating component. The method can therefore be applied to individual body components as well as to already assembled body components, the areas of which to be coated are no longer accessible from the outside in the assembled state. The at least one coating component can comprise a wax of the type described at the outset. It is also possible to use multiple different coating components that are to be applied to the components individually or together. The coating components can be present in solid, particularly granular, form or in liquid form, for example, at room temperature of approximately 20 to 22 degrees Celsius.

The method comprises providing a coating device having a reservoir, comprising a bag for accommodating the at least one coating component. In other words, a bag is provided which is designed to accommodate and hold the at least one coating component. In this respect, the bag material has a tightness and chemical resistance that is sufficient to hold the at least one coating component in predetermined process conditions. The predetermined process conditions can, for example, be selected so that they are easy to adhere to in the production process of the body. They can therefore be adapted to a room temperature, an ambient pressure, or even an ambient humidity, as usually prevails in a production hall. For example, the room temperature can be between 20 and 22 degrees Celsius, the ambient pressure can correspond to atmospheric pressure, and the relative ambient humidity can be between 40 and 60%.

The bag is filled with the at least one coating component and closed.

In a further method step, the bag is arranged and aligned within a predetermined arrangement area of the body component and/or the multiple body components. This can be carried out, for example, by means of a gripper arm of the coating device, which can grip the bag and place it on the component or components according to a predetermined arrangement plan, which it can follow, for example, under computer control.

According to a further method step, if a predetermined opening criterion is present, the bag is opened, in particular automatically, within an opening area aligned with the predetermined coating area, in particular within a predetermined desired opening area of the bag. In other words, if the opening criterion is met, the bag preferably opens without external action, i.e. the bag can already be placed at a location that is no longer accessible from the outside at the time of opening, wherein reliable opening still occurs. The opening can, for example, be accompanied by an acoustic signal so that it can also be checked that the opening has taken place. As a result of the opening, the at least one coating component is released through the open desired opening area at least partially, in particular completely, in the direction of the coating area. To enable this, it can be ensured when aligning the bag that the bag is aligned having its desired opening area, for example having a structural and/or material weak zone, towards the coating area in such a way that the coating component can trickle or flow into the coating area following gravity.

Finally, the coating area is coated using the at least one coating component.

One advantage of the method according to the invention is that body areas can be coated in a supervised and deliberate manner, wherein the bag and its predetermined opening properties can be used to determine very precisely which process conditions result in a coating. Undesired coating and excessive use of coating agents can thus be avoided without having to restrict or adapt the further production process of the body assembly or even the entire vehicle assembly.

The invention also comprises embodiments which result in additional advantages.

One embodiment provides that the predetermined opening criterion, when present, results in the bag melting, dissolving, bursting, and/or tearing open at least, in particular exclusively, within the desired opening area. In particular, the bursting can be accompanied by the above-mentioned acoustic signal (“pop”) for the opening check. The opening mechanisms can occur individually or in any combination. For example, the bag can partially melt and partially burst.

According to one embodiment, the method can comprise the further step of heating the body component and/or the plurality of interconnected body components in the surroundings of the bag to a melting temperature of at least one material component within the predetermined desired opening area of the bag, wherein the opening criterion is met when the melting temperature is reached. In this case, the bag is opened at least partially, in particular completely, in particular automatically, by melting the at least one material component within the predetermined desired opening area. In other words, the heat input into the body component and/or the assembled body components can be increased locally in such a way that the melting temperature of the material component is deliberately reached in the surroundings of the bag. Therefore, extensive heating of the body is not required, which significantly increases the energy efficiency of the process in relation to the known methods. Because the melting material component can only form the bag within the desired opening area, deliberate opening of the bag in this area is also made possible.

According to an advantageous refinement, the material component contains at least one further coating component which is discharged in the direction of the coating area during melting. In other words, the bag material in the desired opening area or even the entire bag can melt completely and thus release a further coating component. In other words, the bag material itself can provide the further coating component, which is made available by melting the bag. In this way no bag residue advantageously remains in the body and a multi-component coating can be used.

Particularly preferably, in the described embodiments in which the bag is opened by melting, the coating component is initially present in the bag in solid form, for example, as a block or granulate. Preferably, a wax having a melting temperature which is lower than the melting temperature of the at least one material component of the bag, in particular between 70 and 90 degrees Celsius inclusive, is used as the at least one coating component. In the embodiments mentioned, the wax is thus preferably solid at room temperature. The melting temperature of the coating component, for example, a wax, is thus preferably below the melting temperature of the material component of the bag, whether in the desired opening area or also for the entire bag material. This ensures that the entire block or the entire granulate is completely melted before the bag is opened, in particular automatically, by the melting process described above at an even higher temperature. The wax is then melted homogeneously and can be discharged into the coating area in a controlled manner. It is also possible to heat the body components repeatedly during the production process without causing undesirable coating, provided that a material component having a sufficiently high melting temperature is selected for the bag, at least within the desired opening area.

It is also possible to use a wax that is already present in liquid form at room temperature and does not need to be melted. Waxes of this type can, for example, cure oxidatively, i.e. upon contact with oxygen, for example air oxygen. The oxidatively curing waxes have further advantages which are described in connection with further embodiments.

The heating can be carried out, for example, by deliberately directing a welding flame or a hot air stream onto the area of the body component or the multiple interconnected body components within which the arrangement area of the bag lies. The heat is preferably introduced from an outer side of the body component opposite to the attached bag. For example, the body component can be provided with a higher thermal conductivity in this area than in the surrounding areas.

Alternatively or additionally, an electrically conductive wire can be arranged within the desired opening area of the bag, which can, for example, be embedded in the material component of the bag. The wire can be connected to a power source so that electrical current can be conducted through the wire, which can result in heating of the wire and melting of the material component in the desired opening area. In this embodiment, it is advantageous if the coating component, as mentioned, is already present in liquid form within the bag at room temperature, so that it does not have to be melted. In this case, it is sufficient to melt the material component in the desired opening area of the bag in order to release the already liquid coating component in the direction of the coating area. There, for example, it can cure oxidatively, i.e. in contact with oxygen.

Two different types of wax can thus be used, wherein each type functions and can be used with each of the opening mechanisms described. The first type is an oxidatively curing wax, which is liquid in the absence of atmospheric oxygen and cures upon contact with air oxygen, for example, after leaving the bag. A second type is a wax that is solid at room temperature, melts when heated, and hardens again automatically at lower temperatures.

A further embodiment provides that a current air humidity in the surroundings of the bag is increased to a predetermined dissolution humidity, from which at least one material component dissolves within the predetermined desired opening area of the bag, wherein the opening criterion is present when the predetermined dissolution humidity is reached. As a result, the bag opens at least partially, in particular completely, in particular automatically, by dissolving the at least one material component within the predetermined desired opening area. In other words, it is not, or not only, melting that results in the opening of the bag, but rather the at least partial dissolution of the bag within the desired opening area as a result of the increased air humidity. The are humidity can be produced, for example, by deliberate vapor deposition of the body component within the arrangement area of the bag. Vapor deposition can also be accompanied by an increase of the ambient temperature, so that the effects of melting and dissolving can advantageously be connected.

Alternatively or additionally, the method can comprise increasing an internal pressure of the bag to a predetermined bursting pressure at which the bag bursts and/or tears open within the desired opening area, wherein the opening criterion is present upon reaching the predetermined bursting pressure, which is in particular at least twice as high as the atmospheric pressure. As a result, the bag is opened at least partially, in particular completely, in particular automatically, by bursting open within the predetermined desired opening area. The internal pressure in the bag can be increased, for example, by pressing on the bag and squeezing out the coating component as from an opened toothpaste tube as soon as the lid (i.e. the desired opening area) has broken off. This local bursting of the bag can be brought about by a deliberate structural weakening of the bag within the desired opening area. Alternatively or additionally, for example, heating the coating component in the bag can cause a gas to escape from it, which also increases the internal pressure, causing the bag to burst. The bursting advantageously results in an even better distribution of the coating component, as it can be ejected from the bag under pressure.

A further embodiment provides that, after being arranged and aligned within the predetermined arrangement area, the bag sinks with its desired opening area onto a mandrel or a blade due to gravity and is pierced or cut open by the mandrel or the blade for at least partial, in particular complete, in particular automatic opening.

Of course, all of the described opening scenarios can be carried out individually or in any combination. The bag can therefore, for example, partially melt and partially dissolve in order to open automatically. The bag can also already be inflated and then sink onto the spike or needle, so that it bursts particularly easily when it comes into contact with the spike or needle tip.

Depending on the opening method selected, the at least one coating material can also be selected. In the opening methods that function without heating above room temperature, a wax is preferably used as the at least one coating component, which is present in a liquid state at a room temperature of 20 to 25 degrees Celsius and cures, for example, by oxidation.

A further embodiment provides that the bag is provided with multiple chambers, wherein each of the chambers has a predetermined desired opening area. In other words, the reservoir of the coating device can be provided with a chambered bag, wherein preferably the chambers are filled with different coating components, wherein the coating components differ in particular in their melting temperatures. In other words, different coating components can be arranged in the chambers of the bag, which can be released gradually.

In order to release the various coating components gradually, it can be intended, for example, to provide a separate desired opening area for each of the chambers, wherein each of the desired opening areas contains a material component having a different melting point. The chambers can thus be opened one after another with increasing ambient temperature and release the coating components gradually. Analogously, this is of course possible with a different dissolution humidity for the individual material components of the chambers.

One embodiment provides that the bag is glued, clamped, and/or magnetically fastened during the arrangement and alignment within the arrangement area. The clamping can be assisted, for example, by means of one or more hooks in the body component. An outer shape of the bag can be adapted to a hook geometry in such a way that the bag can only be positioned in the hook(s) in the correct orientation, wherein the correct orientation comprises that the bag is aligned having its desired opening area in the direction of the coating area. The bag can also have a self-adhesive surface, using which it can be adhesively bonded within the arrangement area.

A further embodiment provides that the bag remains at or on the body component and/or the multiple body components after the coating area has been coated using the at least one coating component, wherein corrosion protection for the body component and/or the multiple body components is provided by the bag, in particular in the arrangement area. This is particularly advantageous when the bag is applied to the untreated metallic body surface, so that no or only little corrosion coating material can be applied in the arrangement area of the bag. There, the bag itself provides corrosion protection.

For applications or usage situations that can arise in the method and which are not explicitly described here, it can be provided according to the method that a fault message and/or a request for input of user feedback is output and/or a standard setting and/or a predetermined initial status are set.

A further aspect of the invention relates to a coating device for coating at least one predetermined area of a body component of a body and/or multiple interconnected body components of the body using at least one coating component according to a method according to one of the described embodiments, wherein the coating device has at least one reservoir having a bag for accommodating the at least one coating component. The bag of the coating device according to the invention has at least one desired opening area and is designed to open, in particular automatically, when a predetermined opening criterion is present in the desired opening area and to release the at least one coating component contained in the bag at least partially, in particular completely, into the predetermined area of the body component and/or the multiple interconnected body components.

A further aspect of the invention relates to such a bag for a coating device according to the invention.

The invention also includes refinements of the coating device according to the invention and/or the bag according to the invention, which have features as already described in the context of the refinements of the method according to the invention. For this reason, the corresponding refinements of the coating device according to the invention and/or the bag according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic representation of a partially assembled motor vehicle body having a predetermined coating area;

FIG. 2 shows a schematic cross-sectional view of a sill and a wheel house having bags in possible arrangement areas;

FIG. 3 shows a schematic representation of another body component, here a door, having a predetermined coating area and a schematic cross-sectional representation of the coating area with the bag arranged;

FIG. 4 shows a schematic representation of a bag; and

FIG. 5 shows a schematic representation of a method for coating a body component according to an embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also to comprise combinations of the features of the embodiments other than those represented. Furthermore, the described embodiments can also be supplemented by further ones of the above-described features of the invention.

In the figures, same reference numerals respectively designate elements that have the same function.

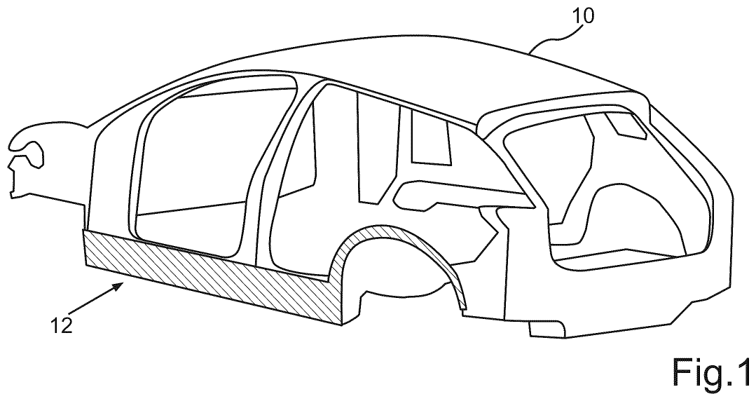

FIG. 1 shows a schematic representation of a partially assembled motor vehicle body 10 having a predetermined coating area 12, which is indicated here by hatching in a sill area and in the area of a wheel house of the body 10. Within the coating area 12, at least one coating component, for example a wax, is preferably to be applied to the bare metal of the body 10.

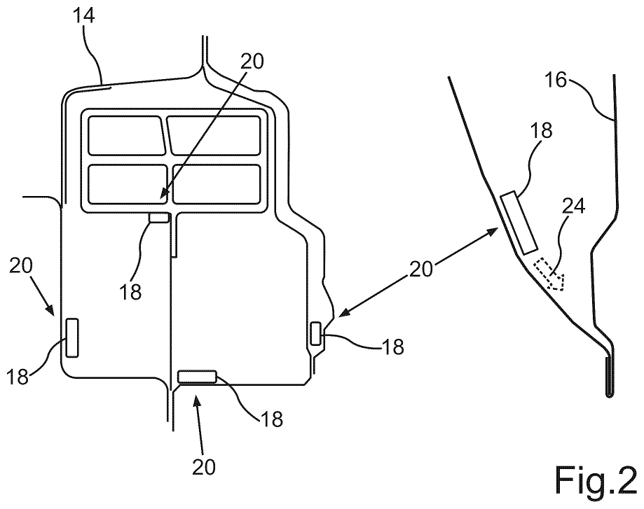

FIG. 2 shows a schematic cross-sectional view of the sill 14 (in the left part of the image) and the wheel house 16 (in the right part of the image). The components are each arrangements of multiple assembled body components, which can, for example, be welded together. As a result, the interiors of the body components may not be accessible or may be difficult to access in many or all assembly steps of the body 10.

In order to coat predetermined coating areas 12 within the sill 14 and/or within the wheel house 16, which are shown here purely by way of example and without any restrictive effect as representative of the other body components of the body 10, bags 18 can be arranged in predetermined arrangement areas 20 of the body components. The bags 18 can be adhesively bonded, clamped, or clipped in the arrangement areas 20. For this purpose, hooks (not shown here) can be arranged on the inner sides of the body components. The bags 18 can also be held magnetically to the metal of the body components, for example by arranging magnets inside them. A respective bag 18 can also be encased by a magnetic fabric or knit, which is used to hold the bag 18 magnetically on a respective body component.

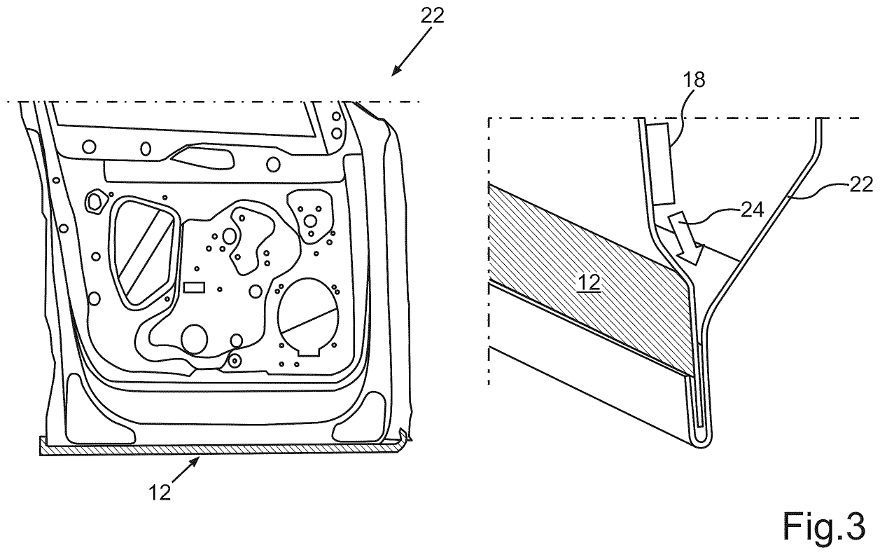

FIG. 3 shows a schematic representation of another body component, here a door 22, having a predetermined coating area 12 and a schematic cross-sectional representation of the coating area 12 having the bag 18 arranged. The bag 18 can open when a predetermined opening criterion is present and release the coating component located therein into the coating area 12, which is schematically represented here by the arrow 24.

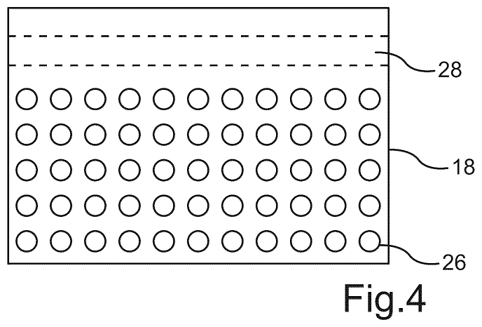

FIG. 4 shows a schematic representation of a bag 18 which is filled with a coating component, for example, here purely by way of example with a wax 26 in granulate form. The bag 18 of FIG. 4 has a desired opening area 28, which is shown here in dashed lines. The desired opening area 28 can be designed in the manner of a predetermined breaking point, which is formed, for example, from a material that has a structural weakening in relation to the rest of the bag 18, for example due to a comparatively thinner material. The bag 18 can also have a material component in the area of the desired opening area 28 which has a lower melting temperature than the rest of the bag 18, so that when a correspondingly selected temperature is applied in the desired opening area 28, the bag 18 melts first and releases the coating component, here the wax 26. Alternatively or additionally, a wire (not shown here), for example, can be embedded in the desired opening area 28, which wire can be supplied with an electric current and thereby heated, due to which the material or at least one material component of the bag 18 preferably melts there in order to release the wax 26. If the wax 26 is initially in granular form, as shown in FIG. 4, it can preferably melt at a lower melting temperature before the bag 18 opens in the desired opening area 28.

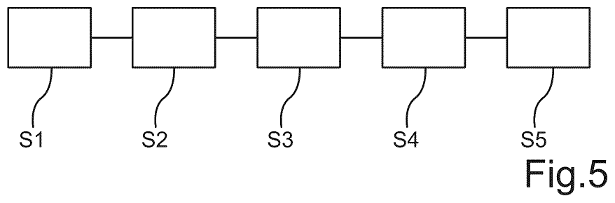

FIG. 5 shows, with reference to the components designated and described in connection with the preceding figures, a schematic representation of a method for coating a body component using a coating component within a predetermined coating area 12 according to an embodiment of the invention.

A step S1 comprises providing a coating device having a reservoir, comprising a bag 18 for accommodating the at least one coating component. In a step S2, the bag 18 is filled using the at least one coating component and then sealed, in particular in a fluid-tight manner. In a step S3, the bag 18 is arranged and aligned within a predetermined arrangement area 20 of the body component. If a predetermined opening criterion is present, in a step S4, the bag 18 automatically opens within a predetermined desired opening area 28 aligned on the predetermined coating area 12, wherein the at least one coating component is dispensed at least partially, in particular completely, through the opened desired opening area 28 in the direction of the coating area 12. Finally, in a step S5, the coating area 12 is coated using the at least one coating component.

The new concept involves the introduction of a coating component, for example a wax 26, into a type of bag 18. The bag 18 can be attached locally (to the individual component or in the sub-OP) in the shell to individual areas of vehicle structures or body components. The bag 18 can later be deliberately opened, allowing the wax 26 to flow out.

In principle, the invention comprises the application to any body component that is to be waxed, such as front longitudinal members, doors, flaps, body cavities, subframes, and/or chassis parts. In connection with FIGS. 1 to 3, the sill 14, the wheel house 16, and the door 22 are explained as exemplary embodiments. The coating areas 12 that are to be waxed are shown (see hatched areas in FIGS. 1 and 3). In the application examples, wax pads are glued as bags 18 onto the walls, in particular the inner walls, of the body components. The wax pads are opened at the desired time so that the wax 26 emerges and is applied to the walls.

The amount of wax 26 can be selected depending on the size and/or shape of the wax pad. The wax pad and/or the body 10 can also be heated locally so that the wax 26 can flow out correspondingly in liquid form and run in liquid form over the wall.

For example, the wax pads are adhesively bonded onto the components, preferably at a comparatively early stage of body construction—the earliest point in time could even be at the supplier, for example, even before the sill 14 is assembled.

The bag envelope of the wax pad preferably has a higher melting temperature than the wax substrate. This allows the wax 26 in the bag 18 to be heated, in particular liquefied, before it exits. The bag envelope is then deliberately opened and the wax 26 flows out of the bag 18 in the direction of the zone/wall/flange/mixed construction area/etc. to be waxed.

Advantages of the invention include the targeted local introduction of wax, so that wax contamination in other areas can be minimized and resource waste can be reduced. In addition, the bags are very versatile; only a few pads can be used for most or all body variants. There is also no need to provide process holes for waxing, which means there is no structural weakening and there is no need to close the process holes with expensive plugs during assembly. In addition, expensive process steps and equipment (wax flooding systems/wax spray systems) for waxing can be eliminated in the factory area. The invention also enables significantly lower energy consumption than the known methods, since, for example, only local heating of the pads is required to release the wax.

Overall, the examples show how wax pads can be used in body construction to accurately wax body components.

1. A method for coating a predetermined coating area of a body component of a body and/or multiple interconnected body components of the body using at least one coating component, comprising the following steps
providing a coating device having a reservoir, comprising a bag filled with the at least one coating component,
arranging and aligning the bag within a predetermined arrangement area of the body component and/or the multiple body components,
if a predetermined opening criterion is present, opening, in particular automatically opening, the bag within an in particular predetermined opening area aligned on the predetermined coating area, wherein the at least one coating component is dispensed at least partially, in particular completely, through the opened desired opening area in the direction of the coating area, and
coating the coating area using the at least one coating component.

2. The method according to claim 1, wherein the predetermined opening criterion, when present, results in the bag melting, dissolving, bursting, and/or tearing open at least, in particular exclusively, within the opening area.

3. The method according to claim 1, further comprising:
heating the body component and/or the multiple interconnected body components in the vicinity of the bag to a melting temperature of at least one material component within the opening area of the bag, wherein the opening criterion is present when the melting temperature is reached, and
at least partial, in particular complete, opening of the bag by melting the at least one material component within the opening area.

4. The method according to claim 3, wherein the material component contains at least one further coating component which is dispensed in the direction of the coating area during melting.

5. The method according to claim 3, wherein a wax having a melting temperature which is lower than the melting temperature of the at least one material component of the bag, in particular between 70 and 90 degrees Celsius inclusive, is used as the at least one coating component.

6. The method according to claim 1, further comprising:
increasing a current air humidity in the surroundings of the bag to a predetermined dissolution humidity, from which at least one material component dissolves within the opening area of the bag, wherein the opening criterion is present when the predetermined dissolution humidity is reached, and
at least partial, in particular complete, opening of the bag by dissolving the at least one material component within the opening area.

7. The method according to claim 1, further comprising:
increasing an internal pressure of the bag to a predetermined bursting pressure at which the bag bursts and/or tears open within the opening area, wherein the opening criterion is present upon reaching the predetermined bursting pressure, which is in particular at least twice as high as the atmospheric pressure, and
at least partial, in particular complete, opening of the bag by bursting the bag within the opening area.

8. The method according to claim 1, wherein the bag, after being arranged and aligned within the predetermined arrangement area, sinks with its opening area onto a mandrel or a blade due to gravity and is pierced or cut open by the mandrel or the blade within the opening area for at least partial, in particular complete, opening.

9. The method according to claim 1, wherein a wax is used as a coating component, which wax is in a liquid state at a room temperature of 20 to 25 degrees Celsius and cures by oxidation.

10. The method according to claim 1, wherein the bag is provided with multiple chambers, wherein each of the chambers has its own opening area.

11. The method according to claim 10, wherein the chambers are filled with different coating components, wherein the coating components differ in particular in their melting temperatures.

12. The method according to claim 1, wherein the bag is adhesively bonded, clamped, and/or magnetically fastened during the arrangement and alignment within the arrangement area.

13. The method according to claim 1, wherein the bag remains at or on the body component and/or the multiple body components after the coating area has been coated using the at least one coating component, wherein corrosion protection for the body component and/or the multiple body components is provided by the bag, in particular in the arrangement area.

14. A coating device for coating at least one predetermined coating area of a body component of a body and/or multiple interconnected body components of the body using at least one coating component according to a method according to claim 1, wherein the coating device has at least one reservoir having a bag, wherein the bag is filled with the at least one coating component,
wherein the bag has at least one opening area and is designed to open, in particular automatically, when a predetermined opening criterion is present in the opening area and to release the at least one coating component at least partially, in particular completely, into the predetermined coating area of the body component and/or the multiple interconnected body components.

15. A bag for a coating device according to claim 14.

16. The method according to claim 2, further comprising:
heating the body component and/or the multiple interconnected body components in the vicinity of the bag to a melting temperature of at least one material component within the opening area of the bag, wherein the opening criterion is present when the melting temperature is reached, and
at least partial, in particular complete, opening of the bag by melting the at least one material component within the opening area.

17. The method according to claim 4, wherein a wax having a melting temperature which is lower than the melting temperature of the at least one material component of the bag, in particular between 70 and 90 degrees Celsius inclusive, is used as the at least one coating component.

18. The method according to claim 2, further comprising:
increasing a current air humidity in the surroundings of the bag to a predetermined dissolution humidity, from which at least one material component dissolves within the opening area of the bag, wherein the opening criterion is present when the predetermined dissolution humidity is reached, and
at least partial, in particular complete, opening of the bag by dissolving the at least one material component within the opening area.

19. The method according to claim 3, further comprising:
increasing a current air humidity in the surroundings of the bag to a predetermined dissolution humidity, from which at least one material component dissolves within the opening area of the bag, wherein the opening criterion is present when the predetermined dissolution humidity is reached, and
at least partial, in particular complete, opening of the bag by dissolving the at least one material component within the opening area.

20. The method according to claim 4, further comprising:
increasing a current air humidity in the surroundings of the bag to a predetermined dissolution humidity, from which at least one material component dissolves within the opening area of the bag, wherein the opening criterion is present when the predetermined dissolution humidity is reached, and
at least partial, in particular complete, opening of the bag by dissolving the at least one material component within the opening area.
